(19) United States
(12) Patent Application Publication
(10) Pub. No.: US 2015/0059525 A1
(43) Pub. Date: Mar. 5, 2015

(54) NdFeB SYSTEM SINTERED MAGNET

(71) Applicant: INTERMETALLICS CO., LTD., Nakatsugawa-shi, Gifu (JP)

(72) Inventors: Masato Sagawa, Kyoto-shi (JP); Naoki Fujimoto, Nakatsugawa-shi (JP); Kazuyuki Komura, Kyoto-shi (JP); Tetsuhiko Mizoguchi, Kyoto-shi (JP)

(21) Appl. No.: 14/389,519

(22) PCT Filed: Mar. 26, 2013
(86) PCT No.: PCT/JP2013/058777

§ 371 Date: Sep. 30, 2014

(30) Foreign Application Priority Data
Mar. 30, 2012 (JP) 2012-082357

(51) Int. Cl. H01F 1/057

(52) U.S. Cl. CPC H01F 1/0577
USPC 75/246

(57) ABSTRACT

The NdFeB system sintered magnet according to the present invention is a NdFeB system sintered magnet produced by diffusing Dy and/or Tb which are/is attached to a surface of a base material produced by orienting powder of a NdFeB system alloy in a magnetic field, and sintering the powder of the NdFeB system alloy, into grain boundaries inside the base material by grain boundary diffusion treatment, wherein a squareness ratio is equal to or higher than 95%. The NdFeB system sintered magnet can be produced by producing a base material of the NdFeB system sintered magnet by using a NdFeB system alloy with lamellas of a rare-earth rich phase dispersed substantially uniformly at predetermined spaces, as a starting alloy, and causing the alloy to occlude hydrogen, without performing heating for desorbing the occluded hydrogen thereafter until a sintering process, and applying grain boundary diffusion treatment to the base material.

### TECHNICAL FIELD

The present invention relates to a NdFeB system sintered magnet. Here, “NdFeB system” is not limited to those consisting of only Nd, Fe and B, but it includes those containing rare earth elements other than Nd, and other elements such as Co, Ni, Cu and Al.

### BACKGROUND ART

NdFeB system sintered magnets were discovered by Sagawa (one of the present inventors) and other researchers in 1982. NdFeB system sintered magnets have high magnetic characteristics far better than those of conventional permanent magnets, and can be manufactured from materials such as Nd (a rare-earth element), iron and boron, which are relatively abundant and inexpensive. Hence, NdFeB system sintered magnets are used in a variety of products, such as battery-assisted bicycle motors, industrial motors, voice coil motors used in hard disks or other apparatuses, high-grade speakers, headphones and permanent magnetic resonance imaging systems.

As the methods for producing NdFeB system sintered magnets, there are known three methods: a sintering method, a method of casting/hot working/aging, and a method that die-upsets a quenched alloy. Among them, the sintering method is the one having excellent magnetic characteristics and high productivity, and industrially established. With the sintering method, fine, dense and uniform structure which is required of a permanent magnet can be obtained.

There is a method called grain boundary diffusion method in which a NdFeB system sintered magnet produced by the sintering method is used as a base material, Dy and/or Tb (hereinafter, “Dy and/or Tb” will be referred to as “R_{H}”) is attached to the surface of the base material by coating, vapour deposition or the like, and the magnet is heated to diffuse R_{H} from the surface of the base material into the inner region of the base material through grain boundaries (Patent Literature 1). By the grain boundary diffusion method, the coercive force of a NdFeB system sintered magnet can be further enhanced.

### CITATION LIST

### Patent Literature

[Patent Literature 1] WO2011/004894

[Patent Literature 2] JP 2005-320628 A

### SUMMARY OF INVENTION

### Technical Problem

A demand for NdFeB system sintered magnets as the permanent magnets for the motors of hybrid or electric cars and the like is expected to grow because of their high magnetic characteristics. However, it should be assumed that automobiles are used under harsh load, so that the motors of the automobiles should assure normal operations under high temperature environments (for example, 180° C.). If a NdFeB system sintered magnet is used at such a high temperature, the magnetic force (magnetization) decreases, and further, it does not return to the original level (irreversible partial demagnetization occurs) even when the temperature is lowered. Decrease in the magnetization and irreversible partial demagnetization as described above may occur by the heat generated in the magnets due to the magnetic fields from armatures.

An object of the present invention is to provide a NdFeB system sintered magnet in which irreversible partial demagnetization under a high-temperature environment hardly occurs.

### Solution to Problem

A NdFeB system sintered magnet according to the present invention aimed at solving the aforementioned problem is a NdFeB system sintered magnet characterized in that the NdFeB system sintered magnet is produced by attaching Dy and/or Tb to a surface of a base material, which is produced by orienting powder of a NdFeB system alloy in a magnetic field and sintering the powder of the NdFeB system alloy, and by diffusing the Dy and/or Tb into grain boundaries inside the base material by grain boundary diffusion treatment, and in that a squareness ratio of the NdFeB system sintered magnet is equal to or higher than 95%.

The squareness ratio mentioned here is the value defined by the ratio Hₖ/H_{cJ} obtained by, as shown in FIG. 7A and FIG. 7B, dividing an absolute value Hₖ of the magnetic field corresponding to the magnetization 10% less than the magnetization at zero magnetic field by a coercive force H_{cj}, in the J-H (magnetization-magnetic field) curve encompassing the first quadrant and the second quadrant.

A permanent magnet of a motor experiences a reverse magnetic field from the current coil. Irreversible partial demagnetization occurs when a reverse magnetic field equal to or larger than the magnetic field corresponding to the inflection point C which appears in the second quadrant of the J-H curve is applied to the magnet. As the coercive force is higher, and the squareness ratio is higher, the magnetic field strength at the inflection point C is larger. Accordingly, as the coercive force and the squareness ratio are higher, the irreversible partial demagnetization is more difficult to occur.

Further, while the coercive force becomes lower as the temperature of the magnet rises, the coercive force and the squareness ratio at a high temperature are larger, in general, as the coercive force and the squareness ratio at a normal temperature (room temperature) are higher. Accordingly, if the coercive force and the square ratio at a normal temperature are both increased, the irreversible partial demagnetization will become more difficult to occur when the temperature of the magnet is high.

As described in Patent Literature 1 and other documents, the coercive force of the NdFeB system sintered magnet is high when the grain boundary diffusion method is used. However, with the NdFeB system sintered magnet produced by the conventional grain boundary diffusion method, a high squareness ratio was unable to be obtained. For example, in Patent Literature 1, the squareness ratio of the NdFeB system sintered magnet produced by the grain boundary diffusion method is 81.5 to 93.4%.

In the NdFeB system sintered magnet according to the present invention, a high coercive force by grain boundary diffusion treatment is obtained, and a high squareness ratio equal to or higher than 95% is exhibited, and therefore, irreversible partial demagnetization hardly occurs, as compared with the conventional NdFeB system magnet. If the adding amount of R_{H} is adjusted and the coercive force is increased to be equal to or larger than 20 kOe, irreversible partial demagnetization does not occur even when the magnet is exposed to the maximum service temperature of 180° C. which is assumed in automobiles and the like. Thus, the NdFeB system sintered magnet according to the present invention can provide high magnetic characteristics as the magnet for a motor.

The NdFeB system sintered magnet according to the present invention can be produced by, for example, suppressing the difference in the R_{H} concentration in the grain boundaries to a low level, and by covering the crystal grains (hereinafter, called “main-phase grains”) of Nd₂Fe₁₄B system compound cubic crystals composing the NdFeB system sintered magnet uniformly with a grain boundary phase mainly composed of a rare-earth rich phase. The reason is as follows.

A grain boundary diffusion method is the method which enhances the coercive force of individual main-phase grains while restraining deterioration of some of the magnetic characteristics such as the maximum energy product and the residual magnetic flux density, by diffusing R_{H} from the boundaries (grain boundaries) of the individual main-phase grains composing a NdFeB system sintered magnet to only the region very close to the grain boundaries inside the individual main-phase grains (refer to Patent Literature 1, for example). Conventionally, in the NdFeB system sintered magnet produced according to a grain boundary diffusion method, R_{H} does not sufficiently diffuse into the grain boundaries located far (deep) from the magnet surface, and a large difference in the concentration of R_{H} remains after grain boundary diffusion treatment between the grain boundaries close to the magnet surface and the grain boundaries far from the magnet surface. As a result, a difference occurs in the coercive force of the individual main-phase grains between the main-phase grains located near the attaching surface and those located far from the attaching surface. Further, if impurities such as carbon exist at a high concentration at a portion of grain boundary, diffusion of R_{H} is blocked at the portion, and the concentration of R_{H} around the portion becomes locally high. This also brings about a difference in the coercive force among the main-phase grains.

While factors which is responsible for the squareness of the J-H curve of a NdFeB system sintered magnet as a whole is not yet clear, the J-H curve of an entire NdFeB system sintered magnet becomes more gradual as the grain boundary structure becomes less uniform and as the difference in the concentration of R_{H} element in the grain boundary phase is more substantial. The reason why the squareness ratio after the grain boundary diffusion treatment of the NdFeB system sintered magnet of Patent Literature 1 is as low as around 81.5 to 93.4% is considered to be the ununiformity of the grain boundary structure and the differences in the R_{H} element concentration in the grain boundary phase.

In relation to the above, the NdFeB system sintered magnet according to the present invention is produced so as to suppress the concentration difference of R_{H} in the grain boundaries to be low, and to constitute a more uniform grain boundary structure, and therefore, the high squareness ratio equal to or higher than 95% can be obtained. In addition, high coercive force can be also obtained by the grain boundary diffusion treatment, and therefore, the NdFeB system sintered magnet in which irreversible partial demagnetization under a high temperature environment hardly occurs can be obtained.

### Advantageous Effects of Invention

The NdFeB system sintered magnet according to the present invention has a high coercive force by the grain boundary diffusion treatment and has a high squareness ratio equal to or higher than 95%, and therefore, irreversible partial demagnetization under a high temperature environment hardly occurs. Therefore, the NdFeB system sintered magnet according to the present invention can be used preferably as the magnet of an automobile motor or the like for which high magnetic characteristics are required.

### BRIEF DESCRIPTION OF DRAWINGS

FIG. 1 A is a flowchart showing one example of a method for producing a NdFeB system sintered magnet according to the present invention, and FIG. 1B is a flowchart showing a production method of a conventional NdFeB system sintered magnet.

FIG. 2A is a schematic view showing an alloy plate having a lamella of a rare-earth rich phase, and FIG. 2B is a schematic view showing alloy powder grains which are obtained by finely pulverizing the alloy plate.

FIG. 3 is a graph showing changes of the magnetic characteristics in the cases of respectively using a strip cast alloy with lamella spaces of approximately 3 μm, and a strip cast alloy with lamella spaces of approximately 4 μm as starting alloys.

FIG. 4 is an optical micrograph of the NdFeB system sintered magnet where a coarse grain is generated after grain boundary diffusion treatment is performed.

FIG. 5 is a graph showing a change of the carbon content in the NdFeB system sintered magnet with respect to addition of the lubricant that is added during the production process.

FIG. 6 is an optical micrograph of the NdFeB system sintered magnet after the grain boundary diffusion process, which is produced preventing generation of coarse grains.

FIG. 7A and FIG. 7B are graphs of a J-H curve showing a relation of a squareness ratio and a point of inflection.

### DESCRIPTION OF EMBODIMENTS

A method for producing a NdFeB system sintered magnet according to the present invention is described with reference to the respective drawings.

### Example

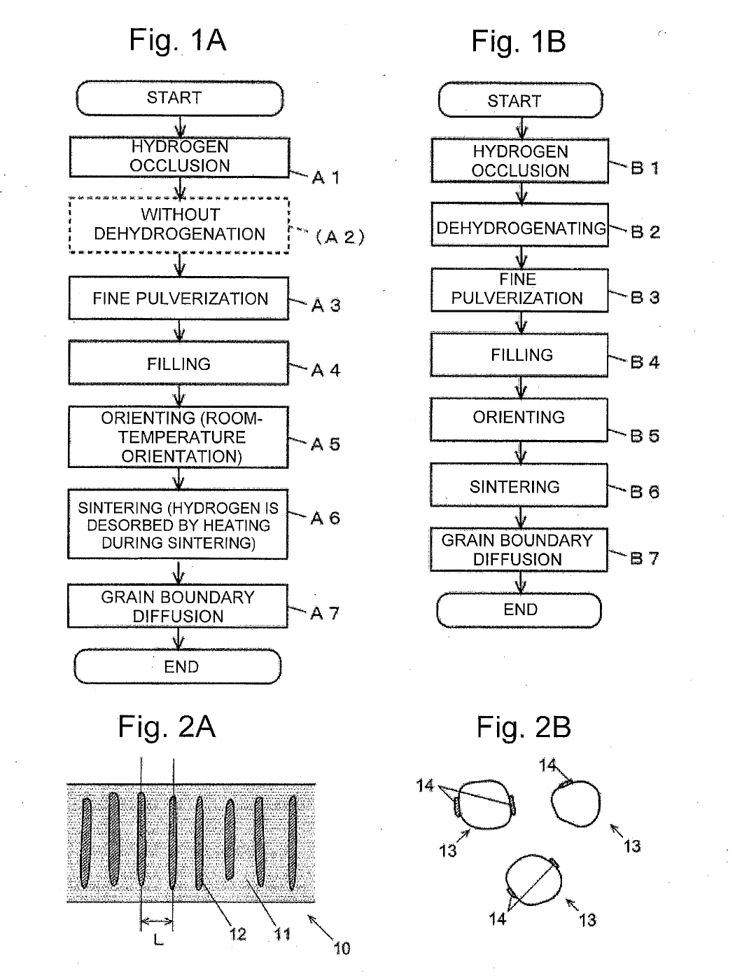

For comparison, the production method of a NdFeB system sintered magnet using a conventional grain diffusion method is described with use of a flowchart of FIG. 1B. The production method of the NdFeB system sintered magnet using the conventional grain boundary diffusion method is broadly divided into seven processes that are a hydrogen occlusion process, a dehydrogenation process, a fine pulverization process, a filling process, an orienting process, a sintering process and a grain boundary diffusion process.

In the hydrogen occlusion process, a thin plate (hereinafter, described as a “NdFeB system alloy plate”) of a NdFeB system alloy (a starting alloy) which is prepared in advance by a strip cast method or the like is caused to occlude hydrogen (step B1). In the dehydrogenation process, the NdFeB system alloy plate by which hydrogen is occluded is heated to approximately 500° C., whereby hydrogen is desorbed from the NdFeB system alloy plate (step B2). By the process, the NdFeB system alloy plate is pulverized into metal pieces with widths up to approximately several millimeters at the maximum. In the fine pulverization process, a lubricant is added to the metal pieces which are thus obtained, and the metal pieces are finely pulverized to the target grain size by a jet mill method or the like (step B3)

In the filling process, a lubricant having alkyl carboxylic acid such as methyl caprylate and methyl myristate as a main component is added to fine powder (hereinafter, called “alloy powder”) which is obtained by the fine pulverization process, and the flowability of the alloy powder is enhanced, after which, the alloy powder is filled in a filling container having a shape necessary to obtain a desired size (step B4). In the orienting process, a magnetic field is applied to the alloy powder together with the filling container, and individual grains of the alloy powder are oriented in the same direction (step B5). In the sintering process, the alloy powder is heated to approximately 950 to 1050° C. together with the filling container (step B6). Thereby, a block of the NdFeB system sintered magnet before R_{H} is diffused is produced. In the grain diffusion process, the block is used as a base material, R_{H} is attached to a predetermined surface of the block by vapour deposition, coating or the like, and the block is heated to approximately 900° C. (step B7).

An aging treatment is sometimes performed after the sintering process and/or the grain boundary diffusion process. The aging treatment is sometimes performed by being divided into a plurality of times.

In relation to the above, the production method of the NdFeB system sintered magnet of the present example is firstly characterized by using an alloy plate 10 in which plate-shaped (called lamella) rare-earth rich phases 12 are dispersed substantially uniformly at predetermined spaces in a main phase 11 as shown in FIG. 2A, as the NdFeB system alloy plate for use in the hydrogen occlusion process. The alloy plate 10 like this can be produced by a strip cast method as described in Patent Literature 2. Further, an average space between lamellas (hereinafter, called “average lamella space”) L can be controlled by regulating a rotational speed of a cooling roller which is used in the strip cast method, and a speed at which molten metal of the NdFeB system alloy is supplied to the cooling roller.

Secondly, the production method of the NdFeB system sintered magnet of the present example is characterized by not performing a dehydrogenation process (FIG. 1A). That is, in the production method of the NdFeB system sintered magnet of the present example, hydrogen is occluded by the hydrogen occlusion process, and thereafter, processes up to the sintering process are performed without going through a dehydrogenation process by heating. The hydrogen which is occluded by the alloy powder is desorbed by heating at the time of the sintering process. Hereinafter, the method which produces the base material of the NdFeB system sintered magnet without performing a dehydrogenation process is called “a base material production method without dehydrogenation”. In relation to this, the conventional method which produces the base material of the NdFeB system sintered magnet by performing a dehydrogenation process by heating is called “a base material production method with dehydrogenation”.

The reason of using the alloy plate in which the lamellas of a rare-earth rich phase are dispersed substantially uniformly at predetermined spaces in the hydrogen occlusion process is as follow.

As described above, in the hydrogen occlusion process, the NdFeB system alloy is caused to occlude hydrogen. Thereby, the NdFeB system alloy is embrittled, and since the rare-earth rich phase occludes more hydrogen than the main phase, embrittlement advances especially in the rare-earth rich phase lamella portions. Therefore, in the next fine pulverization process, the NdFeB system alloy is finely pulverized into substantially the same size as the spaces of the rare-earth rich phase lamellas. As a result, the alloy powder with substantially uniform grain sizes can be obtained, and parts 14 of the rare-earth rich phase lamella are attached to surfaces of individual grains 13 of the alloy powder, as shown in FIG. 2B.

As a result that the alloy powder with substantially uniform grain sizes is obtained, the sizes of the main-phase grains in the base material which are obtained after the sintering process also become uniform. Thereby, sizes of magnetic domains become uniform, and the magnetic characteristics of the base material after sintering are improved. Further, the rare-earth rich phase is attached to the surfaces of the individual grains of the alloy powder, whereby the rare-earth rich phase is dispersed uniformly into the grain boundaries in the base material. The rare-earth rich phase becomes a main passage at the time of diffusing R_{H} in the boundary diffusing process, and therefore, the rare-earth rich phase is dispersed uniformly into the grain boundaries in the base material, whereby R_{H} is diffused sufficiently deeply from the attaching surface in the grain boundary diffusion process, and a R_{H} concentration difference with respect to a depth direction hardly occurs.

In the fine pulverization process, a target value of the grain size of the alloy powder to be produced is set to be equal to or smaller than the average lamella space of the NdFeB system alloy. This is because if the grain size of the alloy powder is set to be larger than the average lamella space of the NdFeB system alloy, the number of alloy powder grains containing the rare-earth rich phase inside becomes large, and the rare-earth rich phase that is dispersed into the grain boundaries relatively decreases in the base material after sintering, whereby the above described effect cannot be sufficiently obtained.

Further, in order to obtain the above described effect, the average lamella space of the alloy plate 10 is desirably made approximately equivalent to the grain size (several micrometers) of the alloy powder. There is the correlation between the thickness of the alloy plate 10 and the average lamella space, and therefore, in order to make the average lamella space of the alloy plate 10 approximately several micrometers, the thickness of the alloy plate 10 is adjusted to be equal to or smaller than 350 μm in average.

Further, the reason of using the base material production method without dehydrogenation is as follows.

As described above, a lubricant is added in the fine pulverization process and the filling process. A lubricant is generally an organic substance, and contains a lot of carbon. In the conventional base material production method with dehydrogenation, part of the carbon remains inside the base material, and brings about reduction in the magnetic characteristics of the base material. Further, the carbon remaining inside the base material forms carbon-rich phases with a high carbon concentration in the grain boundaries. The carbon-rich phase plays a role like a dam at the time of diffusing R_{H} through the grain boundaries, and hinders diffusion of R_{H}. Thereby, R_{H} hardly reaches a sufficiently deep region from the attaching surface. Further, as a result that R_{H} is blocked by the carbon-rich phase, the concentration of R_{H} becomes locally high around the carbon-rich phase, and the concentration of R_{H} becomes ununiform.

In order to prevent carbon from remaining in the base material, reduction of the use amount of the lubricant is conceivable, but the lubricant needs to be included to some extent in order to enhance flowability of the powder.

In relation to the above, in the base material production method without dehydrogenation, a dehydrogenation process is not performed, and therefore, the alloy powder is a hydrogen compound. The hydrogen in the hydrogen compound reacts with carbon contained in the lubricant by heating at the time of the sintering process, and becomes a hydrocarbon compound to be discharged. As a result, the concentration of the carbon remaining in the base material is reduced, and the magnetic characteristics of the base material are improved. Further, since a carbon-rich phase is difficult to form in the grain boundaries, R_{H} is diffused uniformly by the grain boundary diffusion treatment, and the coercive force of the main-phase grains in the NdFeB system sintered magnet after the grain boundary diffusion treatment become substantially uniform. As impurities, oxygen and nitrogen are sometimes included, and these impurities also react with hydrogen and become H₂O and a gas of a hydronitrogen compound to be discharged.

The production method of the NdFeB system sintered magnet of the present example has the above two characteristics (the rare-earth rich phase lamella alloy, and the base material production method without dehydrogenation), and thereby R_{H} can be uniformly diffused sufficiently deeply from the surface to which R_{H} is attached at the time of the grain boundary diffusion process. As a result, the NdFeB system sintered magnet which is produced by the production method of the present example can obtain a squareness ratio equal to or higher than 95%.

Hereinafter, the production method of the NdFeB system sintered magnet of the present example is described by citing a specific example with reference to FIG. 1A.

In the present example, the NdFeB system alloy powder with the median value D₅₀ of the grain distribution measured by a laser diffraction method being 3 μm was produced by the hydrogen occlusion process (step A1) and the fine pulverization process (step A3) by using the NdFeB system alloy with the average lamella space of 3.7 μm (hereinafter, called “3 μm lamellar alloy”). Further, with respect to the NdFeB system alloy with the lamella space of 4.5 μm (hereinafter, called “4 μm lamellar alloy”), the NdFeB system powder with the median value D₅₀ of the grain distribution measured by a laser diffraction method being 3 μm was produced. An evaluation of the average lamella space was performed by the method described in Japanese Patent No. 2665590. Further, the alloy compositions of the 3 μm lamellar alloy and the 4 μm lamellar alloy are respectively as in Table 1 as follows.

TABLE 1

| | Nd | Pr | Dy | Co | Cu | Al | B | Fe |
|---|---|---|---|---|---|---|---|---|
| 3 μm Lamellar | 23.9 | 5.06 | 2.42 | 0.01 | 0.12 | 0.17 | 0.94 | bal. |
| Alloy | | | | | | | | |
| 4 μm Lamellar | 23.8 | 4.98 | 2.55 | 0.00 | 0.10 | 0.18 | 0.96 | bal. |
| Alloy | | | | | | | | |

Note:
Unit of each numerical value is wt %.

Specific procedures of the hydrogen occlusion process and the fine pulverization process are as follows. After the alloy of Table 1 is embrittled by hydrogen occlusion (step A1), while thermal dehydrogenation is not performed (step A2), 0.05 wt % of alkyl carboxylic acid is mixed with the obtained metal piece, and the metal piece is finely pulverized in a nitrogen gas flow by using a 100AFG-type jet mill manufactured by Hosokawa Micron Corporation (step A3). At this time, the grain size of the powder after fine pulverization is adjusted to be 3 μm in the median value D₅₀ of the grain distribution measured by a laser type grain distribution measuring device (HELOS&RODOS manufactured by Sympatec Corp.).

After the fine pulverization process, 0.07 wt % of alkyl carboxylic acid is mixed in the produced alloy powder, and the alloy powder is filled in a filling container (step A4). Subsequently, while the fine powder remains to be filled in the filling container, the powder is oriented in a magnetic field (step A5), and the powder is sintered by being heated at 950 to 1000° C. for four hours under vacuum together with the filling container (step A6). Further, as the aging treatment after the sintering, the powder is quenched after being heated at 800° C. for 0.5 hours under an inert gas atmosphere, and is further heated at 480 to 580° C. for 1.5 hours to be quenched.

By the above processes, eight base materials each with a magnetic pole face of 7 millimeters square, and a thickness of 3 mm were produced with respect to each of the 3 μm lamellar alloy and the 4 μm lamellar alloy, and the magnetic characteristics of the base materials were determined. The results are shown in Table 2 and Table 3 as follows.

TABLE 2

| | Br | Js | HcB | HcJ | BHMax | Br/ | | |
|---|---|---|---|---|---|---|---|---|
| No. | (G) | (G) | (Oe) | (Oe) | (MGOe) | Js (%) | HK (Oe) | SQ (%) |
| S1 | 13844 | 14539 | 13511 | 20585 | 46.92 | 95.2 | 19827 | 96.3 |
| S2 | 13894 | 14614 | 13562 | 20552 | 47.28 | 95.1 | 19846 | 96.6 |
| S3 | 13824 | 14405 | 13502 | 20406 | 46.82 | 96.0 | 19662 | 96.4 |
| S4 | 13785 | 14446 | 13525 | 20461 | 46.80 | 95.4 | 19688 | 96.2 |
| S5 | 13701 | 14411 | 13391 | 20457 | 46.02 | 95.1 | 19582 | 95.7 |
| S6 | 13737 | 14290 | 13409 | 20489 | 46.22 | 96.1 | 19619 | 95.8 |
| S7 | 13688 | 14238 | 13384 | 20345 | 45.98 | 96.1 | 19559 | 96.1 |
| S8 | 13739 | 14240 | 13492 | 20440 | 46.52 | 96.5 | 19675 | 96.3 |

TABLE 3

| | Br | Js | HcB | HcJ | BHMax | Br/ | | |
|---|---|---|---|---|---|---|---|---|
| No. | (G) | (G) | (Oe) | (Oe) | (MGOe) | Js (%) | HK (Oe) | SQ (%) |
| C1 | 13454 | 14073 | 13079 | 20732 | 44.53 | 95.6 | 20043 | 96.7 |
| C2 | 13447 | 14145 | 13065 | 20834 | 44.48 | 95.1 | 20180 | 96.9 |
| C3 | 13491 | 14251 | 13097 | 20798 | 44.73 | 94.7 | 20127 | 96.8 |
| C4 | 13483 | 14190 | 13088 | 20845 | 44.68 | 95.0 | 20173 | 96.8 |
| C5 | 13507 | 14157 | 13110 | 20758 | 44.85 | 95.4 | 20062 | 96.6 |
| C6 | 13465 | 14076 | 13076 | 20708 | 44.61 | 95.7 | 20005 | 96.6 |
| C7 | 13540 | 14176 | 13154 | 20956 | 45.11 | 95.5 | 20272 | 96.7 |
| C8 | 13459 | 14070 | 13079 | 20849 | 44.57 | 95.7 | 20130 | 96.6 |

The base materials S1 to S8 in the tables are the base materials produced from the 3 μm lamellar alloy, and the base materials C1 to C8 are the base materials produced from the 4 μm lamellar alloy. Further, Bᵣ in the tables is a residual magnetic flux density (the magnitude of the magnetization J or the magnetic flux density B at the time of a magnetic field H of 0 on the J-H curve or the B-H curve), Jₛ is saturation magnetization (the maximum value of the magnetization H_{cB} is the coercive force defined by the B-H curve, H_{cJ} is the coercive force defined by the J-H curve, (BH)ₘₐₓ is the maximum energy product (the maximum value of the product of the magnetic flux density B and the magnetic field H on the B-H curve), Bᵣ/Jₛ is the degree of orientation, Hₖ is the value of the magnetic field H at the time of the magnetization J being 90% of the residual magnetic flux density Bᵣ, and SQ is the squareness ratio (Hₖ/H_{cJ}). As the numerical values of these characteristics are larger, better magnetic characteristics are obtained.

Measurement of the magnetic characteristics of Table 2 and Table 3 was performed by a pulse magnetization measurement device. The pulse magnetization measurement device was manufactured by Nihon Denji Sokki co., ltd (product name: Pulse BH Curve Tracer BHP-1000), with the maximum applied magnetic field of 10T and measurement precision of ±1%. The pulse magnetization measurement device is suitable for evaluation of a high H_{cJ} magnet which is the target of the present invention. However, it is known that as compared with a magnetization measurement device by ordinary direct-current magnetic field application (also called a direct-current B-H tracer), a pulse magnetization measurement device tends to show lower value of the squareness ratio SQ on the J-H curve. For example, the squareness ratio SQ of 95% which is measured by a direct-current magnetization measurement device is approximately 90% when measured by a pulse magnetization measurement device.

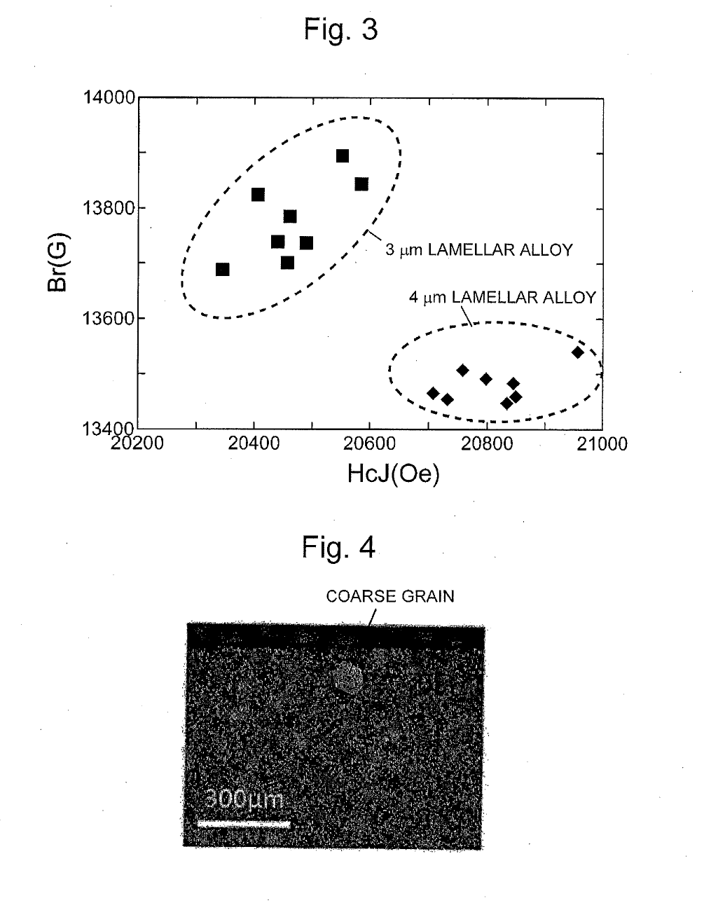

Theses base materials all obtain the numerical value of the squareness ratios equivalent to or larger than 95%. Further, FIG. 3 is the graph showing the magnetic characteristics of the respective base materials in Table 2, and as shown in FIG. 3, it is found that in the base materials S1 to S8, relatively high residual magnetic flux density Bᵣ is obtained, whereas in the base materials C1 to C8, relatively high coercive force H_{cJ} is obtained.

Further, in all the base materials shown in Table 1, high degree of orientation Bᵣ/Jₛ which is around 95% is obtained. This is because as a result that thermal dehydrogenation was not performed, the magnetic anisotropy of the individual grains of the alloy powder becomes low, and the coercive force of the respective grains is reduced. When the coercive force of the individual grains is low, reverse magnetic domains generate in individual grains when the applied magnetic field is decreased after the alloy powder is oriented, and each grain develops a multi-domain structure. As a result, the magnetization of each grain decreases, which alleviates the deterioration in the degree of orientation due to the magnetic interaction among neighbouring grains, so that a high degree of orientation is obtained.

To the base materials S1 to S8 and C1 to C8 of the above, the grain boundary diffusion treatment is applied (step A7). The specific conditions of the grain boundary diffusion treatment are as follows.

First, the paste prepared by adding 0.07 g of silicone oil to 10 g of the mixture obtained by mixing the TbNiAl alloy powder of 92 wt % of Tb(R_{H}), 4.3 wt % of Ni and 3.7 wt % of Al and silicone grease by a weight ratio of 80:20 is applied to each of both magnetic pole faces (faces of 7 millimeters square) of the base materials by 10 mg.

Next, the rectangular parallelepiped base material to which the above described paste is applied is placed on a tray of molybdenum provided with a plurality of pointed supports, and the rectangular parallelepiped base material is heated in a vacuum of 10⁻⁴ Pa while being supported by the supports. The heating temperature is 800 to 950° C., and the heating temperature is four hours. Subsequently, the base material is quenched to about a room temperature, after which, it is heated at 480 to 560° C. for one and a half hours and once more quenched to about a room temperature.

By the above grain boundary diffusion treatment, 16 kinds of samples in total, that are T1 to T8 and D1 to D8 were produced. T1 to T8 are the samples corresponding to the base materials S1 to S8 respectively, and D1 to D8 are the samples corresponding to the base materials C1 to C8 respectively. The result of measurement for these samples by the pulse magnetization measurement device is shown in Table 4 and Table 5 as follows.

TABLE 4

| | | Br | Js | HcB | HcJ | BHMax | Br/Js | HK | |
|---|---|---|---|---|---|---|---|---|---|
| No. | | (G) | (G) | (Oe) | (Oe) | (MGOe) | (%) | (Oe) | SQ (%) |
| T1 | S1 | 13446 | 14045 | 13179 | 32349 | 44.44 | 95.7 | 31857 | 98.5 |
| T2 | S2 | 13478 | 14189 | 13185 | 32197 | 44.58 | 95.0 | 31667 | 98.4 |
| T3 | S3 | 13455 | 14094 | 13152 | 33144 | 44.42 | 95.5 | 32640 | 98.5 |
| T4 | S4 | 13402 | 14080 | 13114 | 32513 | 44.02 | 95.2 | 31786 | 97.8 |
| T5 | S5 | 13405 | 14113 | 13121 | 32963 | 44.12 | 95.0 | 32371 | 98.2 |
| T6 | S6 | 13411 | 14138 | 13092 | 32613 | 44.05 | 94.9 | 31576 | 96.8 |
| T7 | S7 | 13399 | 14106 | 13087 | 32931 | 44.04 | 95.0 | 32306 | 98.1 |
| T8 | S8 | 13425 | 14072 | 13155 | 32290 | 44.26 | 95.4 | 31710 | 98.2 |

TABLE 5

| | | | Br | Js | HcB | HcJ | BHMax | Br/Js | HK | SQ |
|---|---|---|---|---|---|---|---|---|---|---|
| No. | | | (G) | (G) | (Oe) | (Oe) | (MGOe) | (%) | (Oe) | (%) |
| D1 | C1 | C1 | 13212 | 13772 | 12841 | 32534 | 42.90 | 95.9 | 30223 | 92.9 |
| D2 | C2 | C2 | 13284 | 13944 | 12923 | 32537 | 43.36 | 95.3 | 30347 | 93.3 |
| D3 | C3 | C3 | 13196 | 13908 | 12817 | 33743 | 42.69 | 94.9 | 30148 | 89.3 |
| D4 | C4 | C4 | 13247 | 13900 | 12873 | 33077 | 43.09 | 95.3 | 3.278 | 91.5 |
| D5 | C5 | C5 | 13296 | 13942 | 12908 | 30417 | 43.48 | 95.4 | 28615 | 94.1 |
| D6 | C6 | C6 | 13291 | 13932 | 12906 | 30031 | 43.43 | 95.4 | 28215 | 94.0 |
| D7 | C7 | C7 | 13296 | 13982 | 12924 | 31511 | 43.41 | 95.1 | 29706 | 94.3 |
| D8 | C8 | C8 | 13233 | 13936 | 12864 | 31366 | 43.03 | 95.0 | 29608 | 94.4 |

As shown in Table 4, in the samples T1 to T8, the result of extremely high squareness ratios that are 96.8 to 98.5% are obtained. As compared with this, the squareness ratios of the samples D1 to D8 shown in Table 5 are between 90.4 and 94.4%, and are lower than the squareness ratios at the time of the base materials shown in Table 3.

It is cited as the reason of reduction in the squareness ratios of the samples D1 to D8 that the strip cast alloy (the starting alloy) with the average lamellar space of 4.5 μm is finely pulverized to the alloy powder with (the median value D₅₀ of) the grain size of 3 μm. When the grain size of the alloy powder after finely pulverized is too small with respect to the average lamella space of the strip cast alloy, the rare-earth rich phase lamellas detach from the alloy powder. When the base material is produced by using the alloy powder from which the rare-earth rich phase lamellas are detached, the aforementioned effect of uniformly dispersing the rare-earth rich phase into the grain boundaries in the base material is not obtained, and as a result, R_{H} does not uniformly diffuse in the grain boundary diffusion treatment.

Accordingly, in the production method of the NdFeB system sintered magnet of the present example, care should be taken so that the grain sizes of the alloy powder grains after fine pulverization do not become too small with respect to the average lamella space of the strip cast alloy.

As above, with the production method of the NdFeB system sintered magnet of the present example, a high squareness ratio equal to or higher than 95% can be obtained while the coercive force is enhanced by the grain boundary diffusion treatment. In the present example, the base material is produced according to the base material production method without dehydrogenization, and there is the matter that requires attention at the time of using the method.

As described above, the impurities in carbon and the like can be decreased by the base material production method without dehydrogenization. However, if the amount of impurities is decreased excessively, the main-phase grains grow by heating of the grain boundary diffusion treatment, and coarse grains may be generated as shown in FIG. 4 (approximately 100 μm in the micrograph in FIG. 4). If a coarse grain is generated like this, the squareness ratio becomes low. In order to restrain the main-phase grains from growing at the time of the grain boundary diffusion treatment, it is desirable that impurities are included in the base material to some extent.

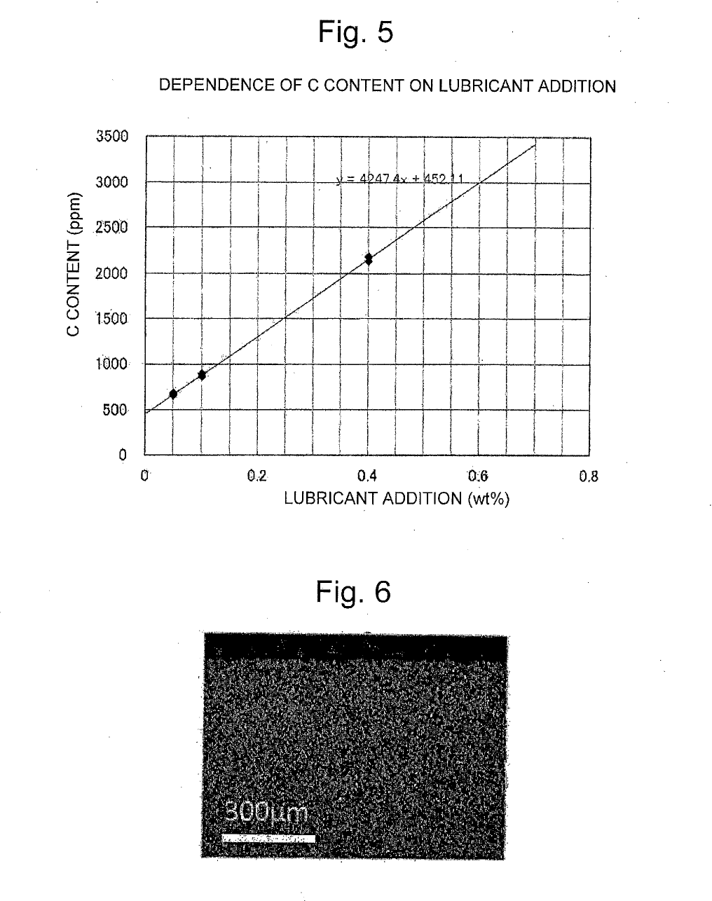

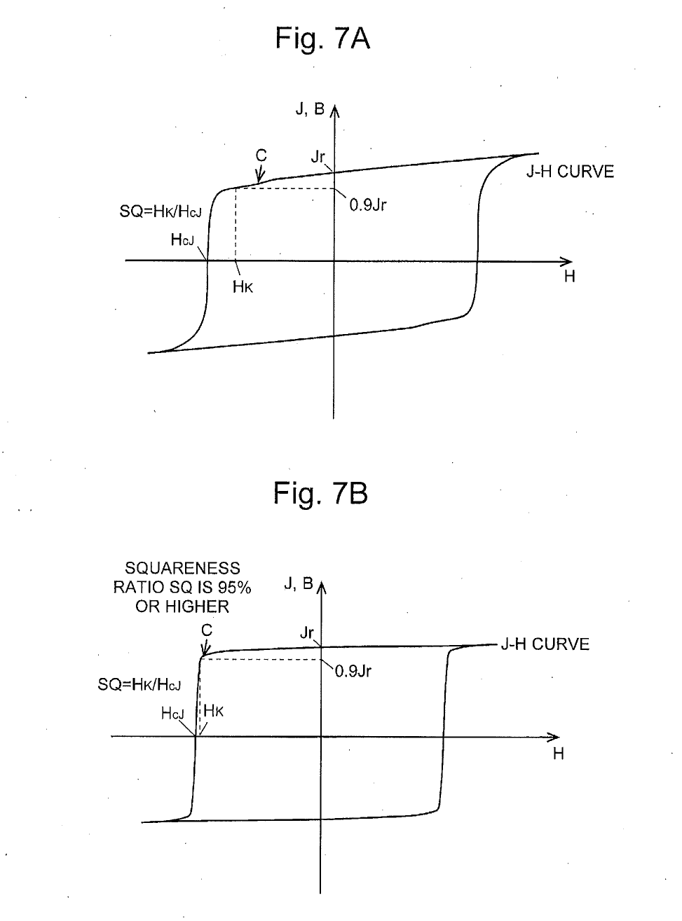

In order to obtain high magnetic characteristics while preventing generation of a coarse grain, in the NdFeB system sintered magnet after the grain boundary diffusion treatment, the content of carbon is set to be equal to or larger than 500 ppm, the content of oxygen is set to be equal to or larger than 500 ppm, the content of nitrogen is set to be equal to or larger than 150 ppm, and the total content of these elements is set to be within a range of 1150 ppm or more to 3000 ppm or less. As the method for adjusting the contents of these elements, there is the method which adjusts the amount of the lubricant which is added to the alloy powder after the NdFeB system alloy is pulverized. For example, in the case of the lubricant of alkyl carboxylic acid which is used in the present example, the addition amount of the lubricant is set at 0.01 wt % or more and 0.6 wt % or less, whereby the content of carbon in the NdFeB system sintered magnet after the grain boundary diffusion treatment can be adjusted to be 500 ppm to 3000 ppm (FIG. 5).

When the contents of carbon, oxygen and nitrogen of the NdFeB system sintered magnet of sample T1 were respectively measured, the carbon content was 950 ppm, the oxygen content was 820 ppm, and the nitrogen content was 170 ppm. Further, when the optical micrograph of the sample was taken, a coarse grain was not generated (FIG. 6). Further, when the average grain size of the main-phase grain was calculated, the average grain size was 2.8 μm.

Further, generally in the grain boundary diffusion method, as the thickness of the base material increases, the difference of the R_{H} concentrations near the attaching surface and at the center portion becomes larger, and the squareness ratio becomes lower, whereas in the production method of the present example, the NdFeB system sintered magnet with the squareness ratio equal to or higher than 95% was able to be produced by the grain boundary diffusion method when the thickness is 1 mm or more and 10 mm or less.

### REFERENCE SIGNS LIST

10 . . . Alloy Plate
11 . . . Main Phase
12 . . . Rare-earth Rich Phase Lamella
13 . . . Alloy Powder Grain
14 . . . Part of Rare-earth Rich Phase Lamella

1. A NdFeB system sintered magnet produced by attaching Dy and/or Tb to a surface of a base material which is produced by orienting powder of a NdFeB system alloy in a magnetic field and sintering the powder of the NdFeB system alloy, and diffusing Dy and/or Tb into grain boundaries inside the base material by grain boundary diffusion treatment,
wherein a squareness ratio is equal to or higher than 95%.

2. The NdFeB system sintered magnet according to claim 1,
wherein the squareness ratio is equal to or higher than 96%.

3. The NdFeB system sintered magnet according to claim 1,
wherein the NdFeB system alloy is produced by a strip cast method for lamellas of a rare-earth rich phase to align at predetermined spaces.

4. The NdFeB system sintered magnet according to claim 3,
wherein an average value of the spaces is equal to or smaller than 3.7 μm.

5. The NdFeB system sintered magnet according to claim 3,
wherein a median value D₅₀ of a grain distribution measured by a laser diffraction method, of the powder is equal to or smaller than the space.

6. The NdFeB system sintered magnet according to claim 1,
wherein the base material is produced by causing the NdFeB system alloy to occlude hydrogen, and roughly pulverizing the NdFeB system alloy, without performing heating for desorbing the occluded hydrogen until the sintering.

7. The NdFeB system sintered magnet according to any claim 1,
wherein a total of contents of oxygen, carbon and nitrogen in the NdFeB system sintered magnet is 1150 ppm or more and 3000 ppm or less.

8. The NdFeB system sintered magnet according to claim 7,
wherein a content of the carbon is equal to or larger than 500 ppm.

9. The NdFeB system sintered magnet according to claim 7,
wherein a content of the oxygen is equal to or larger than 500 ppm.

10. The NdFeB system sintered magnet according to claim 7,
wherein a content of the nitrogen is equal to or larger than 150 ppm.

11. The NdFeB system sintered magnet according to claim 1,
wherein an amount of a lubricant which is added after the powder is produced is 0.01 wt % or more and 0.6 wt % or less.

12. The NdFeB system sintered magnet according to any claim 1,
wherein a degree of orientation of the NdFeB system sintered magnet is equal to or higher than 95%.

13. The NdFeB system sintered magnet according to claim 1,
wherein an average value of a thickness of the NdFeB system alloy is equal to or smaller than 350 μm.

14. The NdFeB system sintered magnet according to claim 1,
wherein an average grain size of grains to be a main phase in the NdFeB system sintered magnet is equal to or smaller than 4.5 μm.

15. The NdFeB system sintered magnet according to claim 1,
wherein a thickness of the NdFeB system sintered magnet is 1 mm or more and 10 mm or less.
